(19) United States
(12) Patent Application Publication
(10) Pub. No.: US 2010/0147767 A1
(43) Pub. Date: Jun. 17, 2010

(54) Method for purifying waste saline waters without reagent waste

(76) Inventor: Gerald J. Grott, Phoenix, AZ (US)

Correspondence Address: THE LUTHER LAW FIRM, PLC, 10575 N 114TH STREET, SUITE 103, SCOTTSDALE, AZ, 85259, US

(21) Appl. No.: 12/316,725

(22) Filed: Dec. 15, 2008

(51) Int. Cl. B01J 49/00

(52) U.S. Cl. 210/670

(57) ABSTRACT

Waste saline waters are purified by contacting with a cation exchange resin in hydrogen form, then with a WBA resin and, if desired, with a SBA resin. The cation exchange resin is regenerated with a strong acid reagent. The WBA resin is regenerated with ammonium hydroxide reagent. The SBA resin is regenerated with an alkali metal hydroxide. The residual reagent values in the spent regenerants are applied to the soil as amendments, fertilizer, for pH control, wind erosion control, deicing roadways and in Enhanced Oil Recovery.

This invention relates to methods of purifying waste saline waters.

More particularly, the invention concerns such methods in which a strong acid and ammoniacal reagents are employed.

In the preferred embodiment, the invention provides such a method in which the reagent values are preserved or even enhanced.

### BACKGROUND OF THE INVENTION

There is a historical and ever-increasing need to recover, purify and re-use water formerly regarded as “waste.” Such waste waters include irrigation runoff, produced water from petroleum and gas fields, deicing runoff, animal wastes, salty groundwaters and streams and the like, as well as spent brines from chemical processes, including various water treatments.

These wastes are saline, i.e., they contain dissolved nitrate, sulfuric, chloride, phosphoric and carbonate salts of sodium, calcium, magnesium and other metals in various proportions and mixtures thereof, totaling 0.15% by weight or more. They may also include trace amounts of dangerous impurities such as hydrocarbon residues, arsenic, selenium, perchlorates and the like.

Many processes have been proposed for recovering, purifying and re-using waste saline waters, but the widespread use of these prior processes has been hampered because of problematical economics. In particular, the costs of reagents used in the prior processes have proven almost prohibitive in large scale water recovery and reuse operations. Such large scale operations are now becoming almost mandatory because of widespread water shortages and because of intractable public health, land contamination and related problems.

It is therefore clear that methods are needed for large scale water recovery, purification and reuse which conserve costly reagents. In particular, it would be highly desirable to provide such methods in which the reagents are not only conserved, but are actually converted to higher value products which are in short supply for other needful uses.

### BRIEF DESCRIPTION OF THE INVENTION

I have now discovered an integrated method of purifying waste saline waters with acidic and ammoniacal reagents in which these reagent values are completely converted to more costly products that are immediately needed for other uses.

Briefly, in accordance with my invention I provide a method of purifying waste saline waters with acidic and ammoniacal reagents, while preserving or enhancing the reagent values. My method comprises, in combination, contacting said waste water with a cation exchange resin in hydrogen form, to separate cations therefrom, yielding spent cation exchange resin and acidic water; regenerating the spent cation exchange resin with a strong acid to produce a spent regenerant liquid containing salts of the separated cations with the strong acid; contacting the acidic water with a weak base anion exchange resin in hydroxyl form, to produce a deionized water stream and a second spent regenerant liquid stream comprising ammonium salts of the anions in the waste water; and regenerating the weak base ion exchange resin with ammonium hydroxide; and applying compositions comprising the salts of one or both regenerant liquids to the soil.

### BRIEF DESCRIPTION OF THE DRAWINGS

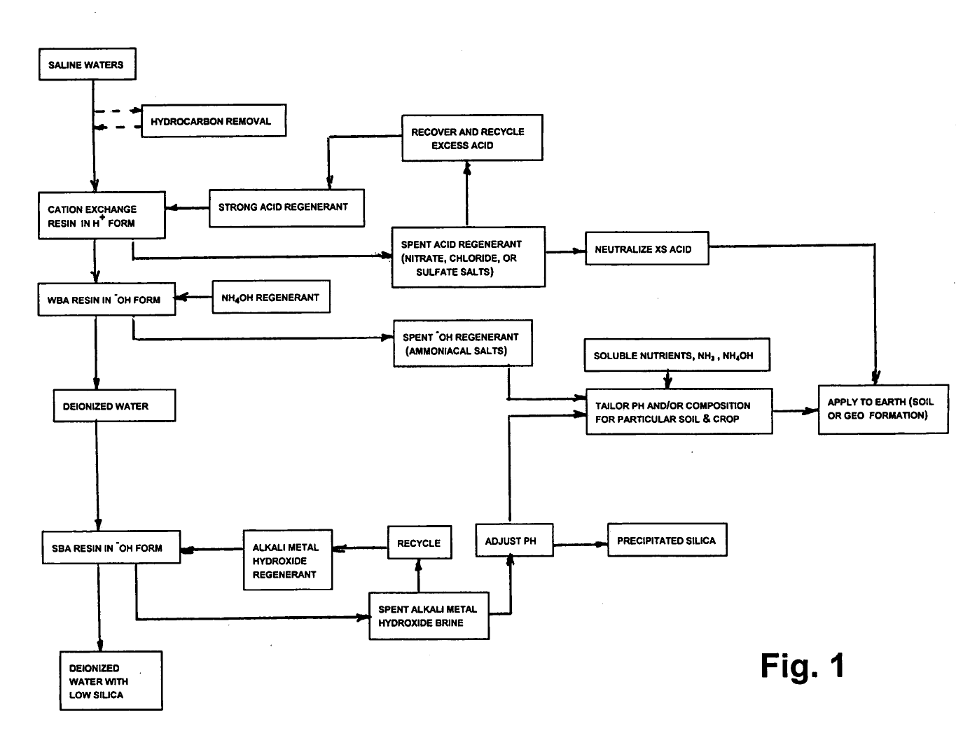

The methods of the invention, including other, further and more specific advantages and embodiments thereof, including the presently preferred embodiment will be understood by those skilled in the art in view of the drawing, in which FIG. 1 is a flow sheet depicting various embodiments of the method of the invention.

### DEFINITIONS

As used herein the terms:
“saline water” means water containing at least 0.15% by weight of the dissolved nitrate, sulfuric, chloride, phosphoric and carbonate salts of sodium, calcium, magnesium and other metals and mixtures thereof.
“strong acid” means an acid which is a member selected from the group comprising nitric acid, sulfuric acid, hydrochloric acid and phosphoric acid.
“ammoniacal” means ammonia, ammonium hydroxide and salts thereof.
“applying to the earth” means applying the indicated material to the soil as an amendment, e.g., to adjust soil characteristics such as the SAR, acidity or alkalinity, etc., as a fertilizer, such as potassium or sodium nitrate, sulfate and chloride and ammonium nitrate, sulfate or chloride, as a surface treatment to prevent or reduce wind erosion, dust formation, etc., and includes injecting the indicated material into geological formations, e.g., for Enhanced Oil/Gas Recovery operations.

### DETAILED DESCRIPTION OF THE INVENTION

The use of ion-exchange in treating water is a mature technology, understood well by persons skilled in the art. Consequently, this detailed description will not focus on details which are not essential to understanding and practicing the invention or which are not essential to identify the presently preferred embodiments thereof.

Referring now to FIG. 1, the saline water to be purified is optionally treated to remove hydrocarbon residues, as indicated by the dashed lines. The saline water is than contacted with a cation exchange resin in hydrogen form to produce an acidic water stream and a spent acid regenerant stream comprising the calcium and magnesium, sodium and potassium salts of the acid used for regeneration of the cation resin.

If the saline waste water initially contains carbonates and/or bicarbonates (such as Produced Water from coal bed methane wells), it is preferred to first contact the waste water with a Weak Acid Cation (“WAC”) resin to remove calcium and magnesium ions associated with the carbonates and then contact the resulting water with a Strong Acid Cation (“SAC”) resin to remove the remaining cations associated with other anions. In such case the spent regeneration brine from regeneration of the SAC resin can be used to regenerate the WAC resin, decreasing the amount of strong acid use in proportion to the amounts of carbonate and bicarbonates in the saline water.

The regenerant stream can be treated, e.g., preferably by distillation, to recover excess acid, which is recycled to regenerate further SAC resin. Any excess acid remaining in the regenerant stream or the excess acid in the entire regenerate stream is neutralized, e.g., with limestone or dolomite, to produce a fertilizer which is applied to soil, preserving and using the entire value of the strong acid regenerating reagent as nitrate, sulfate or chloride salts, depending on the strong acid used.

Preferably, the strong acid is nitric acid, which allows conservation and use of all of the nitrogen values in the acid in the form of a higher-value nitrate fertilizer comprising calcium nitrate and/or magnesium nitrate and/or sodium nitrate salts. Alternatively, the acid neutralization step can be omitted and the salts with excess strong acid can be applied to the earth to lower the pH of excessively alkaline soils.

The softened water stream from the acid exchange step is then contacted with a Weak Base Anion (“WBA”) resin to produce a first purified water stream with low salinity. The WBA resin is regenerated with ammonium hydroxide and the spent regenerant, containing valuable ammoniacal salts can be applied directly to the earth as higher value fertilizer. Preferably, I add other soluble nutrients, amendments, etc., to tailor the composition to the needs of the particular crop and/or soil to which it is applied.

If desired, the first purified water stream is preferably further purified to remove silicates by contacting it with a Strong Base Cation (“SBA”) resin to produce a second purified water stream of low salinity and low silica content. The SBA resin is regenerated with an alkali metal hydroxide, e.g., sodium or potassium hydroxide. The spent regenerant from the SBA contacting step, containing the valuable alkali metal anions from the regenerant can be recycled to the regenerant supply or, preferably, the pH is adjusted in any suitable way, if needed, and additional amendments, nutrients, etc. are added to tailor the composition to the needs of the particular soil to which it is applied.

### EXAMPLE

The following information is submitted as an example of how to practice the presently preferred embodiment of the invention and not by way of limiting the scope of the invention, which is defined only by the appended claim.

The saline waste water has the following composition:

| | mg/l |
|---|---|
| sodium | 1400 |
| calcium | 530 |
| magnesium | 110 |
| sulfate | 2700 |
| chloride | 720 |

The SAC resin employed is Rhom & Haas Amberlite IR 120H.

The WBA resin employed is Rhom & Haas Amberlite IRQ 67 RF.

The SBA resin employed is Rhom & Haas Amberjet 4200 CL.

The strong acid regenerant contains 6 wt. % nitric acid

The ammonium hydroxide regenerant contains 6 wt. % as NH₃

The alkali metal hydroxide regenerant is 6 wt. % potassium hydroxide.

The cations are removed to below the 10 ppm limit of the analytical method employed.

Having described my invention in such full, clear and concise terms as to enable one skilled in the art to understand and practice it and, having identified the presently preferred embodiments thereof, I claim:

1. A method of purifying waste saline waters with acidic and ammoniacal reagents, while preserving or enhancing the reagent values, comprising, in combination, the steps of
(a) contacting said waste water with a cation exchange resin in hydrogen form, to separate cations therefrom, yielding spent cation exchange resin and acidic water substantially free of cations;
(b) regenerating said spent cation exchange resin with a strong acid to produce a first spent regenerant liquid comprising salts of said separated cations with said strong acid;
(c) contacting said acidic water with a weak base anion exchange resin in hydroxyl form, to produce a deionized water stream and a second spent regenerant liquid stream comprising ammonium salts of the anions in the waste water; and
(d) regenerating the weak base ion exchange resin with ammonium hydroxide; and
(e) applying to the earth at least one member of the group (i) compositions comprising said salts of step (b), and (ii) compositions comprising said salts of setp (c).
